(19) United States
(12) Patent Application Publication
(10) Pub. No.: US 2012/0299982 A1
(43) Pub. Date: Nov. 29, 2012

(54) LIQUID CRYSTAL DISPLAY DEVICE, DISPLAY METHOD, PROGRAM, AND RECORDING MEDIUM

(75) Inventor: Ken Inada, Osaka-shi (JP)

(73) Assignee: SHARP KABUSHIKI KAISHA, Osaka-shi, Osaka (JP)

(21) Appl. No.: 13/577,730

(22) PCT Filed: Feb. 14, 2011
(86) PCT No.: PCT/JP2011/053049

§ 371 Date: Aug. 8, 2012

(30) Foreign Application Priority Data
Feb. 16, 2010 (JP) 2010-031636

(51) Int. Cl. G09G 5/02; G09G 3/36

(52) U.S. Cl. 345/690; 345/88

(57) ABSTRACT

A liquid crystal display device (1) of the present invention includes an image data obtainment section (6), a display (2), and a voltage application section (5), a certain gray scale in a first region of the image being displayed such that the voltage application section (5) applies voltages corresponding to the gray scale respectively on sub-pixels of at least four different elementary colors in a pixel displaying the first region, and the certain gray scale in a second region of the image different from the first region being displayed such that the voltage application section (5) applies, on at least one of sub-pixels in a pixel displaying the second region, a voltage larger than the voltage applied on one of the sub-pixels in the pixel displaying the first region which one corresponds in color to said at least one of the sub-pixels in the pixel displaying the second region, and applies, on at least another one of the sub-pixels in the pixel displaying the second region, a voltage smaller than the voltage applied on another one of the sub-pixels in the pixel displaying the first region which another one corresponds in color to said at least another one of the sub-pixels in the pixel displaying the second region. With this, a liquid crystal display device is provided which can protect privacy without causing a difference in display between regions when viewed from a front direction.

### TECHNICAL FIELD

The present invention relates to a liquid crystal display device for displaying an image by utilizing a viewing angle characteristic, a display method carried out in the liquid crystal display device, a program, and a computer-readable storage medium in which the program is stored.

### BACKGROUND ART

Conventionally, there is a demand that peep at a display device in a mobile telephone or the like is prevented, from a perspective of privacy protection. In view of the circumstance, various peep prevention techniques are proposed. One of these peep prevention techniques is a technique utilizing a viewing angle characteristic of liquid crystal.

For example, Patent Literature 1 discloses an art that a display surface of a liquid crystal display is switched between a wide viewing mode in which an image can be viewed from a wide viewing direction and a narrow viewing mode in which an image can be viewed from a narrow viewing direction. According to the art of Patent Literature 1, in the wide viewing mode, an image is displayed in such a manner as to be viewed identically when the display surface is viewed from a front direction and when viewed from an oblique direction. In contrast, in the narrow viewing mode, an image is displayed in such a manner that when the display surface is viewed from the front direction, the image is viewed identically as in the case of the wide viewing mode, whereas when the display surface is viewed from the oblique direction, the image is viewed differently from when the display surface is viewed from the front direction. This prevents a viewer other than a user of a display device from normally viewing an image viewed by the user of the display device.

Patent Literature 2 discloses an art that liquid crystal in each pixel is switched between two or more alignment modes so that the liquid crystal is viewed with different transmittances when the display panel is viewed from a perpendicular direction and when viewed from an oblique direction. This causes an image to be viewed unclearly by viewers other than a viewer who views the display panel from the perpendicular direction.

Patent Literature 3 discloses an art that, when a user other than a user who logs in a device is detected, an image output condition or an audio output condition is switched to a condition difficult to be recognized.

### CITATION LIST

### Patent Literature

Patent Literature 1
Japanese Patent Application Publication, Tokukai, No. 2009-222943 A (Publication Date: Oct. 1, 2009)

Patent Literature 2
Japanese Patent Application Publication, Tokukai, No. 2009-64025 A (Publication Date: Mar. 26, 2009)

Patent Literature 3
Japanese Patent Application Publication, Tokukai, No. 2008-283578 A (Publication Date: Nov. 20, 2008)

### SUMMARY OF INVENTION

### Technical Problem

According to the art of Patent Literature 1, in the narrow viewing mode, image data is processed so that when the display surface is viewed from the oblique direction, an image is viewed differently from originally intended one. However, such processing of image data makes an image viewed turbulently when the display surface is viewed from the front direction.

That is, when the display surface is viewed from the oblique direction, a normal image is viewed with overlapping of a checkered pattern so as to prevent a peep. This is achieved by (i) supplying pixel data of “189” to each of pixels 50 and 51 in a white part (first region) of the checkered pattern (see (a) of FIG. 12), and (ii) supplying pixel data of “0” to a pixel 60 and pixel data of “255” to a pixel 61 adjacent to the pixel 60 in a black part (second region) of the checkered pattern (see (b) of FIG. 12). FIG. 12 illustrates an exemplary arrangement of pixel data supplied to pixels provided in a display of a conventional display device.

FIG. 13 illustrates luminance factors of individual pixels in the first region and second region of the image viewed from the front direction. FIG. 13 is a view illustrating luminance factors of pixels in a conventional display device viewed from a front direction. Luminance factors of the respective pixels 50 and 51 in the first region of the image are 50% (see (a) of FIG. 13), and an average of luminance factors of respective adjacent four pixels is 50% (see (a) of FIG. 13). In contrast, a luminance factor of a pixel 60 in the second region is 0% and a luminance factor of a pixel 61 in the second region is 100% (see (b) of FIG. 13), and an average of luminance factors of respective adjacent four pixels is 50% like the luminance factors of respective adjacent four pixels in the region 1.

FIG. 14 illustrates luminance factors of individual pixels in the first region and second region of the image viewed from the oblique direction. FIG. 14 is a view illustrating luminance factors of pixels in a conventional display device viewed from an oblique direction. Luminance factors of the respective pixels 50 and 51 in the first region of the image are 80% (see (a) of FIG. 14), and an average of luminance factors of respective adjacent four pixels is 80% (see (a) of FIG. 13). In contrast, a luminance factor of a pixel 60 in the second region is 0% and a luminance factor of a pixel 61 in the second region is 100% (see (b) of FIG. 14), identically with when viewed from the front direction, and an average of luminance factors of respective adjacent four pixels is 50% unlike the luminance factors of respective adjacent four pixels in the first region. Such difference in luminance factor in adjacent four pixels causes the first region and the second region to be viewed differently from each other when viewed from the oblique direction.

However, when viewed from the front direction, adjacent pixels in the second region exhibit so large a difference in luminance factor that the first region and the second region are viewed differently from each other when viewed from the front direction. This gives rise to a problem that an image originally intended to be viewed is displayed in a way difficult to be viewed.

Neither an art of Patent Literature 2 nor an art of Patent Literature 3 is to prevent a peep by making use of a luminance difference between adjacent pixels.

The present invention is made in view of the foregoing problems, and an object of the present invention is to provide a liquid crystal display device capable of protecting privacy without causing a display difference between regions when viewed from a front direction.

### Solution to Problem

In order to attain the object, a liquid crystal display device of the present invention includes: obtainment means for obtaining image data; a display, which displays an image indicated by the image data obtained by the obtainment means and in which a plurality of pixels, each being made up of sub-pixels of at least four different elementary colors, are provided; and application means for applying voltages on the plurality of pixels provided in the display, a certain gray scale in a first region of the image being displayed in such a manner that the application means applies voltages corresponding to the certain gray scale respectively on sub-pixels of at least four different elementary colors in a pixel displaying the first region, and the certain gray scale in a second region of the image which is different from the first region of the image being displayed in such a manner that the voltage application means applies, on at least one of sub-pixels in a pixel displaying the second region, a voltage larger than the voltage applied on one of the sub-pixels in the pixel displaying the first region which one corresponds in color to said at least one of the sub-pixels in the pixel displaying the second region, and the application means applies, on at least another one of the sub-pixels in the pixel displaying the second region, a voltage smaller than the voltage applied on another one of the sub-pixels in the pixel displaying the first region which another one corresponds in color to said at least another one of the sub-pixels in the pixel displaying the second region.

In order to attain the object, a display method of the present invention includes the steps of: (i) obtaining image data indicating an image to be displayed by a display in which a plurality of pixels, each being made up of sub-pixels of at least four different elementary colors, are provided; and (ii) applying voltages on the plurality of pixels provided in the display, a certain gray scale in a first region of the image being displayed in such a manner that in the step (ii), voltages corresponding to the certain gray scale are applied respectively on sub-pixels of at least four different elementary colors in a pixel displaying the first region, and the certain gray scale in a second region of the image which is different from the first region of the image being displayed in such a manner that in the step (ii), on at least one of sub-pixels in a pixel displaying the second region, there is applied a voltage larger than the voltage applied on one of the sub-pixels in the pixel displaying the first region which one corresponds in color to said at least one of the sub-pixels in the pixel displaying the second region, and on at least another one of the sub-pixels in the pixel displaying the second region, there is applied a voltage smaller than the voltage applied on another one of the sub-pixels in the pixel displaying the first region which another one corresponds in color to said at least another one of the sub-pixels in the pixel displaying the second region.

In the liquid crystal display device of the present invention, in a case where an image is displayed with a certain gray scale, a luminance balance in each pixel for realizing the certain gray scale varies from region to region. This makes it possible to carry out a display so that a normal image is prevented from being viewed in a case where the display is viewed from the oblique direction.

Specifically, a plurality of pixels are provided in the display included in the liquid crystal display device, and the image with the certain gray scale is displayed by luminance balance in each of the plurality of pixels. Also, in the liquid crystal display device of the present invention, each of the plurality of pixels is made up of sub-pixels of at least four different elementary colors, and the application means can apply different voltages on the respective sub-pixels in each of the plurality of pixels. As such, in a case where the color with the certain gray scale is displayed by one pixel, there are several variations of voltages applied on respective sub-pixels of the pixel.

In a liquid crystal display, an image corresponding to an identical voltage is displayed differently when viewed from a front direction and when viewed from an oblique direction due to a viewing angle characteristic of liquid crystal. Using this viewing angle characteristic, the liquid crystal display device of the present invention is designed such that a pattern of voltages applied on sub-pixels in each of the pixels varies from region to region when displaying an identical gray scale, so that a normal image is prevented from being viewed when the liquid crystal display device is viewed from the oblique direction.

That is, in the liquid crystal display device of the present invention, a certain gray scale in a first region of the displayed image is displayed in such a manner that the application means applies voltages corresponding to the certain gray scale respectively on sub-pixels of a pixel displaying the first region. The certain gray scale in a second region of the image which is different from the first region of the image is displayed in such a manner that the application means applies, on at least one of sub-pixels of a pixel displaying the second region, a voltage larger than the voltage applied on one of the sub-pixels of the pixel displaying the first region which one corresponds in color to said at least one of the sub-pixels of the pixel displaying the second region, and the application means applies, on at least another one of the sub-pixels of the pixel displaying the second region, a voltage smaller than the voltage applied on another one of the sub-pixels of the pixel displaying the first region which another one corresponds in color to said at least another one of the sub-pixels of the pixel displaying the second region. This causes the first region and the second region to be displayed with different luminances when the display is viewed from the oblique direction. This can cause an image viewable when the display is viewed from the front direction to be difficult to be viewed when the display is viewed from the oblique direction.

Further, in the liquid crystal display device of the present invention, adjacent pixels displaying an identical gray scale do not exhibit a difference in luminance. Consequently, regions on which different patterns of voltages are applied hardly exhibit a difference in viewing. This makes it possible to protect privacy without a difference in display between regions when viewed from the front direction.

### Advantageous Effects of Invention

A liquid crystal display device of the present invention includes: obtainment means for obtaining image data; a display, which displays an image indicated by the image data obtained by the obtainment means and in which a plurality of pixels, each being made up of sub-pixels of at least four different elementary colors, are provided; and application means for applying voltages on the plurality of pixels provided in the display, a certain gray scale in a first region of the image being displayed in such a manner that the application means applies voltages corresponding to the certain gray scale respectively on sub-pixels of at least four different elementary colors in a pixel displaying the first region, and the certain gray scale in a second region of the image which is different from the first region of the image being displayed in such a manner that the voltage application means applies, on at least one of sub-pixels in a pixel displaying the second region, a voltage larger than the voltage applied on one of the sub-pixels in the pixel displaying the first region which one corresponds in color to said at least one of the sub-pixels in the pixel displaying the second region, and the application means applies, on at least another one of the sub-pixels in the pixel displaying the second region, a voltage smaller than the voltage applied on another one of the sub-pixels in the pixel displaying the first region which another one corresponds in color to said at least another one of the sub-pixels in the pixel displaying the second region. This makes it possible to protect privacy without a difference in display between regions when viewed from the front direction.

### BRIEF DESCRIPTION OF DRAWINGS

FIG. 1 is a block diagram schematically illustrating how a liquid crystal display device is configured in accordance with one embodiment of the present invention.

FIG. 2 is a curve graph illustrating a relationship between image data and a luminance factor in each of R, G, and B sub-pixels provided in a display of the liquid crystal display device in accordance with one embodiment of the present invention.

FIG. 3 is a curve graph illustrating a relationship between image data and a luminance factor in a white sub pixel provided in the display of the liquid crystal display device in accordance with one embodiment of the present invention.

FIG. 4 illustrates an exemplary arrangement of image data supplied to pixels in a first region and an exemplary arrangement of image data supplied to pixels in a second region in the liquid crystal display device in accordance with one embodiment of the present invention.

FIG. 5 is a graph illustrating a relationship between a gamma curve and a luminance factor when the display of the liquid crystal display device in accordance with one embodiment of the present invention is viewed from a front direction.

FIG. 6 is a graph illustrating a relationship between a gamma curve and a luminance factor when the display of the liquid crystal display device in accordance with one embodiment of the present invention is viewed from an oblique direction.

FIG. 7 is a view illustrating luminance factors in the pixels in the first region and the pixels in the second region (see FIG. 4) when the display of the liquid crystal display device is viewed from the front direction.

FIG. 8 is a view illustrating luminance factors in the pixels in the first region and the pixels in the second region (see FIG. 4) when the display of the liquid crystal display device is viewed from the oblique direction.

FIG. 9 is a view explaining a process to create W data from input data in the liquid crystal display device in accordance with one embodiment of the present invention.

FIG. 10 is a view explaining a process to create R, G, B, and W data from input data in the liquid crystal display device in accordance with one embodiment of the present invention.

FIG. 11 is a view explaining another process to create R, G, B, and W data from input data in the liquid crystal display device in accordance with one embodiment of the present invention.

FIG. 12 illustrates exemplary arrangements of pixel data supplied to pixels provided in a display of a conventional display device.

FIG. 13 is a view illustrating luminance factors of the pixels when the display of the conventional display device is viewed from a front direction.

FIG. 14 is a view illustrating luminance factors of the pixels when the display of the conventional display device is viewed from an oblique direction.

### DESCRIPTION OF EMBODIMENTS

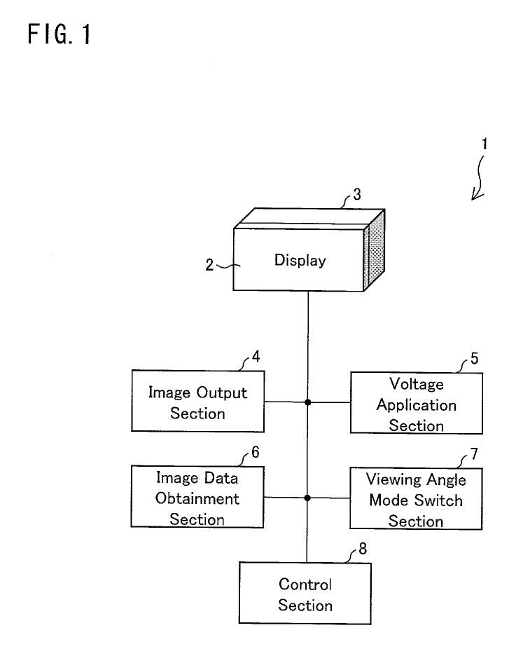

A liquid crystal display device in accordance with an embodiment of the present invention is described below with reference to FIGS. 1 through 11.

(Configuration of Liquid Crystal Display Device 1)

With reference to FIG. 1, the following description will discuss how a liquid crystal display device 1 is configured in accordance with the present embodiment. FIG. 1 is a block diagram schematically illustrating how the liquid crystal display device 1 is configured in accordance with the embodiment of the present invention.

As illustrated in FIG. 1, the liquid crystal display device 1 includes a display 2, a backlight 3, an image output section 4, a voltage application section 5 (application means), an image data obtainment section 6 (obtainment means), a viewing angle mode switch section 7, and a control section 8.

The liquid crystal display device 1 is a display device for carrying out peep prevention display. The “peep prevention display” means displaying an image in such a manner that the image is viewed as a normal image when a user views the display 2 from a front direction and the image is viewed differently from the normal image when a viewer views the display 2 from an oblique direction. The “normal image” means an image (i) which is displayed, in conformity with a preset rule, in accordance with image data obtained by the image data obtainment section 6 and (ii) which is displayed by applying a voltage for which no change in voltage application pattern is caused by the voltage application section 5 (later described).

In the liquid crystal display device 1 of the present embodiment, luminance balance in each pixel for displaying a certain gray scale in an image varies from region to region. This enables the image to be viewed differently when the display 2 is viewed from the front direction and when viewed from the oblique direction.

Specifically, the display 2 of the liquid crystal display device 1 includes a plurality of pixels, and a certain gray scale in an image is produced by luminance balance in each of the plurality of pixels. In the liquid crystal display device 1 of the present embodiment, each of the plurality of pixels is made up of sub-pixels of at least four different elementary colors. The voltage application section 5 can apply voltages of different amplitudes on respective sub-pixels of each of the plurality of pixels. In the circumstances, in a case where a certain grayscale in an image is displayed by one pixel, that is, a combination of sub-pixels of four different elementary colors, amplitudes of the voltages applied on the respective sub-pixels of the pixel have several variations.

In the display 2, an image corresponding to an identical voltage is displayed differently when viewed from a front direction and when viewed from an oblique direction due to a viewing angle characteristic of liquid crystal. Using this viewing angle characteristic, the liquid crystal display device 1 is designed such that a pattern of voltages applied on sub-pixels in each of the pixels varies from region to region when displaying a color with an identical gray scale, so that a normal image is prevented from being viewed when the liquid crystal display device 2 is viewed from the oblique direction.

That is, in the present embodiment, a certain gray scale in a first region of an image displayed by the display 2 is displayed in such a manner that the voltage application section 5 applies voltages corresponding to the certain gray scale respectively on sub-pixels of a pixel displaying the first region, and the certain gray scale in a second region of the image which is different from the first region of the image is displayed in such a manner that the voltage application section 5 applies, on at least one of sub-pixels of a pixel displaying the second region, a voltage larger than the voltage applied on one of the sub-pixels of the pixel displaying the first region which one corresponds in color to said at least one of the sub-pixels of the pixel displaying the second region, and the application section 5 applies, on at least another one of the sub-pixels of the pixel displaying the second region, a voltage smaller than the voltage applied on another one of the sub-pixels of the pixel displaying the first region which another one corresponds in color to said at least another one of the sub-pixels of the pixel displaying the second region. This causes the first region and the second region to be displayed with different luminances when the display 2 is viewed from the oblique direction. This can cause an image viewable when the display is viewed from the front direction to be difficult to be viewed when the display is viewed from the oblique direction.

The sub-pixels of at least four different elementary colors in each pixel are not particularly limited. For example, red, green, blue, and white (hereinafter, sometimes referred to as “R”, “G”, “B”, and “W”, respectively) sub-pixels can be used as the sub-pixels of at least four different elementary colors in each pixel. Note that the white sub-pixel is a monochrome sub-pixel and displays a black color at a gray scale of “0” and a white color at a gray scale of “100”.

It is preferable that (i) the at least one of sub-pixels of each pixel displaying the second region is a white sub-pixel and the at least another one of the sub-pixels of each pixel displaying the second region includes a red sub-pixel, a green sub-pixel, and a blue sub-pixel, or (ii) the at least one of sub-pixels of each pixel displaying the second region includes a red sub-pixel, a green sub-pixel, and a blue sub-pixel and the at least another one of the sub-pixels of each pixel displaying the second region is a white sub-pixel.

For example, in a case where a color with a certain grayscale is displayed, the color thus displayed would become different from an originally intended color if a balance between luminances of the respective red, green, and blue sub-pixels is changed. In order to deal with this, a balance between voltages applied on the respective red, green, and blue sub-pixels is proportionally adjusted so that, even in a case where there is a change in pattern of voltages applied on the respective red, green, and blue sub-pixels, the balance between luminances of the respective red, green, and blue sub-pixels is prevented from being changed. This makes it possible to display the originally intended color with the certain grayscale based on any of a plurality of possible variations of voltage application patterns.

Further, in the liquid crystal display device 1 of the present embodiment, adjacent pixels displaying an identical gray scale do not exhibit a difference in luminance. Consequently, regions on which different patterns of voltages are applied hardly exhibit a difference in viewing. This makes it possible to protect privacy without a difference in display between regions when viewed from the front direction. Note that a display control method carried out in the liquid crystal display device will be detailed later.

The display 2 displays an image indicated by image data obtained by the image data obtainment section 6. The display 2 may be a liquid crystal display.

The backlight 3 is a light source of the display 2 and illuminates the display 2 from a backside of the display 2. Note that, although the backlight is used as the light source of the display 2 in the present embodiment, the light source of the display 2 is not limited to this.

The image output section 4 supplies, to the display 2, the image data obtained by the image data obtainment section 6.

The voltage application section 5 applies voltages on the respective plurality of pixels provided in the display 2. Specifically, the voltage application section 5 applies voltages on the respective plurality of pixels in accordance with pixel data contained in the image data obtained by the image data obtainment section 6. In a case where the display mode of the liquid crystal display device 1 is switched by the viewing angle mode switch section 7, the voltage application section 5 varies a voltage application pattern in each predetermined region, depending on to what display mode the display mode of the liquid crystal display device 1 is switched. However, even in a case where the voltage application pattern in each predetermined region is thus varied, voltages applied in each pixel correspond to image data.

The image data obtainment section 6 obtains image data indicating an image to be displayed by the display 2. For example, the image data includes pixel data, such as color information and gray scale information, of each pixel provided in the display 2.

The viewing angle mode switch section 7 switches the display mode of the liquid crystal display device 1 between the wide viewing angle mode and the narrow viewing angle mode. The wide viewing angle mode is a display mode in which an image is viewed identically when the display 2 is viewed from the front direction and when viewed from the oblique direction. The wide viewing angle mode can be selected in a case where it is not necessary to prevent a peep. In contrast, the narrow viewing angle mode is a display mode in which an image viewable when the display 2 is viewed from the front direction is difficult to be viewed when the display 2 is viewed from the oblique direction. In the liquid crystal display device 1 of the present embodiment, when the display mode is switched to the narrow viewing angle mode, the voltage application section 5 varies the voltage application pattern with respect to each region. Note that the display mode of the liquid crystal display device 1 may be switched to the wide viewing angle mode or the narrow viewing angle mode by the viewing angle mode switch section 7 when, for example, input reception means (not illustrated) receives a switch instruction from a user.

The control section 8 controls each operation of the liquid crystal display device 1.

Note that the liquid crystal display device 1 is not particularly limited. For example, the liquid crystal display device 1 can be applied in a mobile telephone, an electronic book reader, a portable game console, a personal digital assistant (PDA), a laptop computer, an automatic teller machine, and an electronic point of sale information management (EPOS) device.

(Detail of Peep Prevention Display)

The following description will discuss, in detail, a case where the display mode of the liquid crystal display device 1 is switched to the narrow viewing mode, that is, a case where a peep prevention display is carried out.

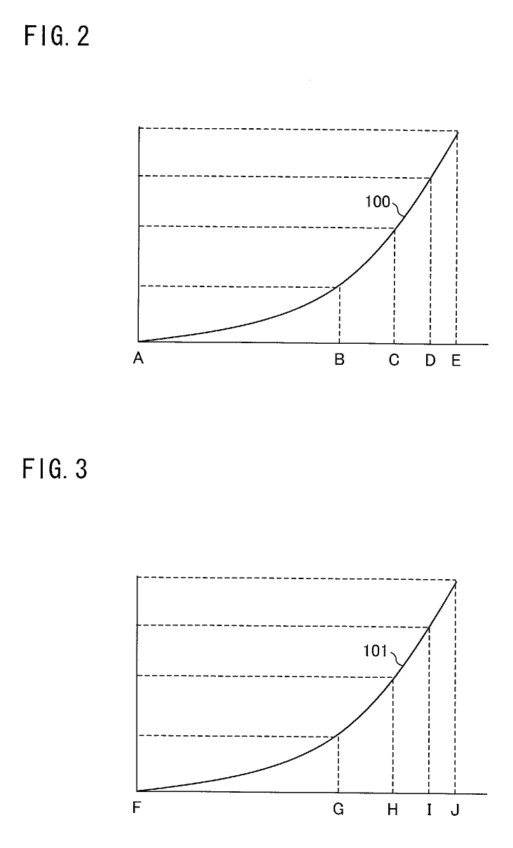

As early described, each of the plurality of pixels provided in the display 2 is made up of sub-pixels of at least four different elementary colors. Also, in a case where a color with a certain grayscale is displayed by one pixel, there are several variations of voltages applied on respective sub-pixels in a pixel. FIG. 2 is a curve graph illustrating a relationship between pixel data and a luminance factor in each of the R, G, and B sub-pixels provided in the display 2 of the liquid crystal display device 1. FIG. 3 is a curve graph illustrating a relationship between pixel data and a luminance factor in the white sub-pixel provided in the display 2. Note that the luminance factor is shown on a longitudinal axis and the pixel data is shown on a horizontal axis in each of FIGS. 2 and 3.

For example, in a case where (i) a color is displayed with a gray scale of “50” and (ii) the luminance factors of the respective R, G, and B sub-pixels are set to 0% (luminance factors corresponding to a point “A” on a graph 100 (see FIG. 2)), the luminance factor of the W sub-pixel is set to 100% (a luminance factor corresponding to a point “J” on a graph 101 (see FIG. 3)). In contrast, in a case where (i) a color is displayed with a gray scale of “50” and (ii) the brightness factors of the respective R, G, and B sub-pixels are set to 50% (luminance factors corresponding to a point “C” on the line 100 (see FIG. 2)), the luminance factor of the W sub-pixel is set to 50% (a luminance factor corresponding to a point “H” on the curve 101 (see FIG. 3)). Note that the luminance factors of the respective R, G, B, and W sub-pixels in case of the gray scale of “50” are not limited to either case above.

Even in a case where the color is displayed with the identical gray scale, there are thus a plurality of possible combinations of (i) the luminance factors of the respective R, G, and B sub-pixels and (ii) the luminance factor of the W sub-pixel. This allows a pattern of voltages applied on respective sub-pixels of each pixel to vary from region to region. With this, the liquid crystal display device 1 controls the display 2 in such a manner that an image viewable when the display 2 is viewed from the front direction is difficult to be viewed when the display 2 is viewed from the oblique direction.

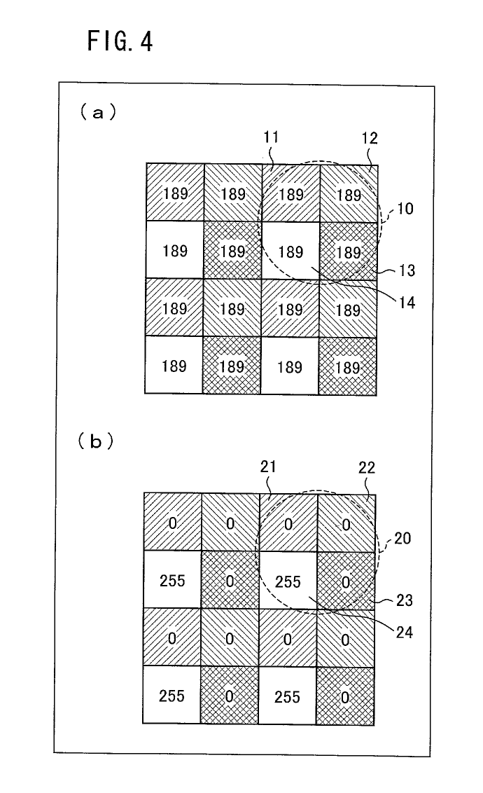

For example, in a case where a first region of an image is displayed with a gray scale of “50”, pixel data of “189” is commonly supplied to each of a red sub-pixel 11, a green sub-pixel 12, a blue sub-pixel 13, and a white sub-pixel 14 in a pixel 10 (see (a) of FIG. 4). In contrast, in a case where a second region of the image is displayed with a gray scale of “50”, (i) pixel data of “0” is commonly supplied to each of a red sub-pixel 21, a green sub-pixel 22, and a blue sub-pixel 23 in a pixel 20 and (ii) pixel data of “255” is supplied to a white sub-pixel 24 in the pixel 20 (see (b) of FIG. 4). FIG. 4 illustrates an exemplary arrangement of pixel data supplied to pixels in the first region and an exemplary arrangement of pixel data supplied to pixels in the second region in the liquid crystal display device 1. The voltage application section 5 applies (i) voltages on respective sub-pixels of each pixel displaying the first region, in accordance with the pixel data thus supplied to the pixels in the first region, and (ii) voltages on respective sub-pixels of each pixel displaying the second region, in accordance with the pixel data thus supplied to the pixels in the second region.

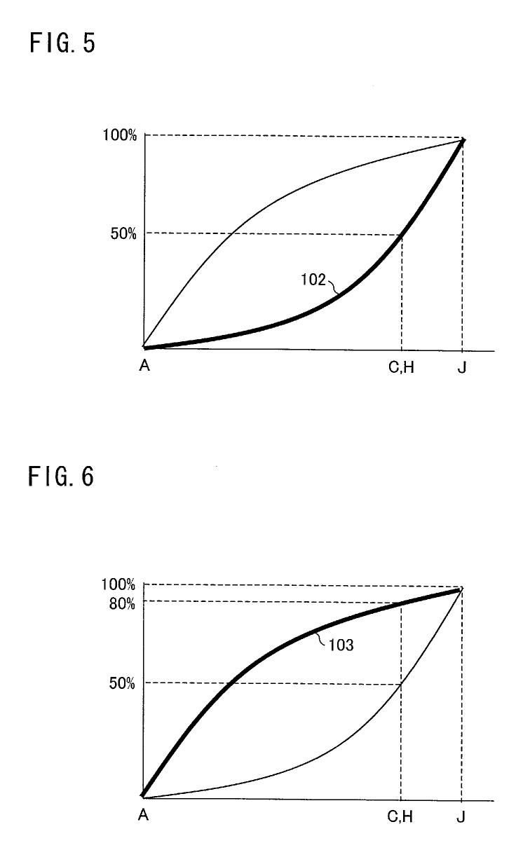

That is, the pixel data of each of the R, G, and B sub-pixels in the first region correspond to the point “C” (see FIG. 2), and the pixel data of the W sub-pixel in the first region correspond to the point “H” (see FIG. 3). As such, in a case where the first and second regions of the image are viewed from the front direction, the first region is viewed with luminance factors of the R, G, B, and W sub-pixels of 50% (see FIG. 5), and the second region is viewed with luminance factors of the R, G, and B pixels of 0% and a luminance factor of the W sub-pixel of 100% (see FIG. 5). FIG. 5 is a graph illustrating a relationship between a gamma curve 102 and a luminance factor when the display 2 is viewed from the front direction.

In contrast, in a case where the first and second regions of the image are viewed from the oblique direction, the first region is viewed with luminance factors of the R, G, B, and W sub-pixels of 80% (see FIG. 6), and the second region is viewed with luminance factors of the R, G, and B sub-pixels of 0% and a luminance factor of the W sub-pixel of 100% (see FIG. 6). FIG. 6 is a graph illustrating a relationship between a gamma curve 103 and a luminance factor when the display 2 is viewed from the oblique direction. Note that “A, C, H, J” in each of FIGS. 5 and 6 correspond to “A, C, H, J” in each of FIGS. 2 and 3, respectively.

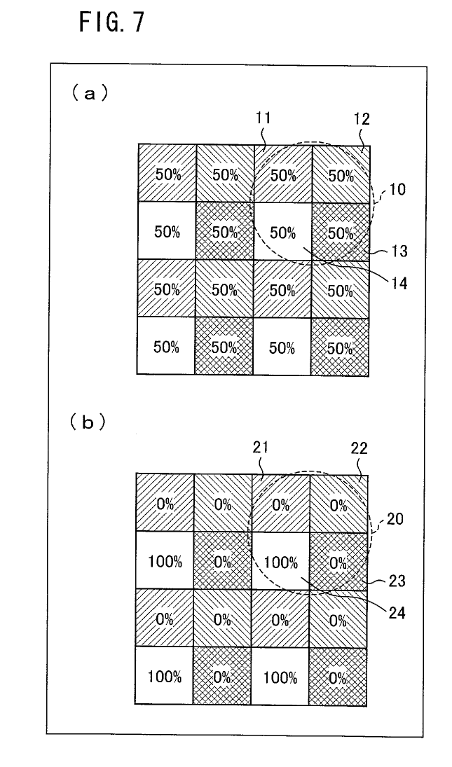

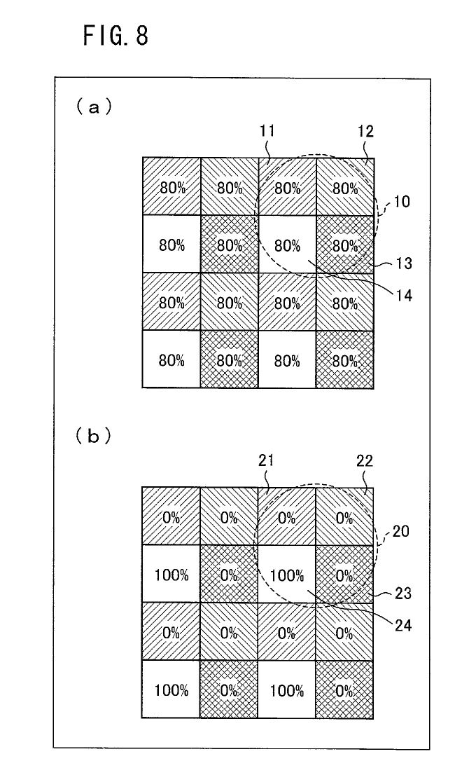

Thus, even in a case where the first and second regions of the image are displayed with the identical gray scale of “50”, voltages applied on respective sub-pixels of a pixel displaying the first region of the image are different from voltages applied on sub-pixels of a pixel displaying the second region of the image. As such, in a case where the display 2 is viewed from the front direction, luminance factors of the respective sub-pixels of the pixel displaying the first region of the image are as illustrated in (a) of FIG. 7, and luminance factors of the respective sub-pixels of the pixel displaying the second region of the image are as illustrated in (b) of FIG. 7. In contrast, in a case where the display 2 is viewed from the oblique direction, luminance factors of the respective sub-pixels of the pixel displaying the first region of the image are as illustrated in (a) of FIG. 8, and luminance factors of the respective sub-pixels of the pixel displaying the second region of the image are as illustrated in (b) of FIG. 8. FIG. 7 is a view illustrating luminance factors of the pixel displaying the first region of the image and the pixel displaying the second region of the image (see FIG. 4) when the display 2 is viewed from the front direction. FIG. 8 is a view illustrating luminance factors of the pixel displaying the first region of the image and the pixel displaying the second region of the image (see FIG. 4) when the display 2 is viewed from the oblique direction.

In a case where the display 2 is viewed from the front direction, (i) luminance factors of respective sub-pixels 11, 12, 13, and 14 of a pixel 10 displaying the first region of the image are 50% so as to make up a luminance factor of 50% in the entire pixel 10 (see (a) of FIG. 7), and (ii) luminance factors of respective sub-pixels 21, 22, 23, and 24 of a pixel 20 displaying the second region of the image are different, but still make up a luminance factor of 50% in the entire pixel 20 (see (b) of FIG. 7).

In contrast, in a case where the display 2 is viewed from the oblique direction, (i) luminance factors of the respective sub-pixels 11, 12, 13, and 14 of the pixel 10 displaying the first region of the image are 80% so as to make up a luminance factor of 80% in the entire pixel 10 (see (a) of FIG. 8), and (ii) a luminance factor of the entire pixel 20 displaying the second region of the image is 50%, as in the case where the display 2 is viewed from the front direction.

In a case where the display 2 is viewed from the front direction, the luminance factor of the entire pixel 10 and the luminance factor of the entire pixel 20 are thus 50%. In contrast, in a case where the display 2 is viewed from the oblique direction, the luminance factor of the entire pixel 10 and the luminance factor of the entire pixel 20 are thus 80% and 50%, respectively. This causes a luminance difference between the first and second regions of the image in a case where the display 2 is viewed from the oblique direction. Because the luminance difference thus caused is viewed as a pattern, the image becomes difficult to be viewed. This makes it possible to protect privacy.

Note that the first and second regions of the image are not limited to particular arrangements and numbers, as long as the first and second regions of the image are partial regions of an image displayed by the display 2. For example, as described in the present embodiment, the first and second regions of the image can be arranged so that, when the display 2 is viewed from the oblique direction, the first and second regions of the image are viewed as a checkerboard pattern due to their luminance difference. Note that, according to the present embodiment, there are two regions to which voltages are applied with different patterns. However, the present embodiment is not limited to this. There may be three regions to which voltages are applied with different patterns.

In the liquid crystal display device 1 of the present embodiment, adjacent pixels displaying images with an identical grayscale do not exhibit a difference in luminance. Consequently, the first and second regions on which respective different patterns of voltages are applied hardly exhibit a difference in viewing.

In a pixel made up of only R, G, and B sub-pixels, if there is a change in luminance balance among the R, G, and B sub-pixels, then a color displayed becomes different from a color that would be displayed if there were no change in luminance balance among the R, G, and B sub-pixels. In view of the circumstance, it is necessary to prevent the change in luminance balance among the R, G, and B sub-pixels. As such, in a case where identical colors in first and second regions are displayed by use of different patterns, it is necessary to carry out control so that luminance balances in respective pixels adjacent to each other vary from each other so that each color in the first and second regions is realized by an average of luminance balances in respective pixels adjacent to each other. That is, in a case where there is a change in luminance balance among the R, G, and B sub-pixels within one pixel, a color displayed by the pixel becomes different from a color corresponding to image data. In order to deal with this, the luminance balance among sub-pixels within the pixel is not changed, whereas a luminance balance (bright/dark) between pixels adjacent to each other is varied, so that a color with a predetermined grayscale is realized by an average of combined luminances of two or more pixels. However, this causes a difference in luminance between the pixels. As such, in a case where a display is viewed from a front direction, a pattern not intended to be viewed is viewed.

In contrast, in the liquid crystal display device 1 of the present embodiment, luminance factors of respective four adjacent pixels 20 belonging to the second region and displaying identical grayscales are 50% (see FIG. 7). That is, because each pixel 20 includes R, G, B, and W sub-pixels, it is possible that a grayscale balance is adjusted within one pixel. This prevents luminance difference from occurring between adjacent pixels. As such, it is possible to protect privacy, without giving rise to a difference between images displayed in the respective regions when seen from a front direction.

(Method for Creating R, G, B, and W Data)

In the liquid crystal display device 1 of the present embodiment, in a case where input data obtained by the image data obtainment section 6 are R, G, and B data, R, G, B, and W data can be created by a method described as follows. Note that how the R, G, B, and W data are created is not particularly limited to the method. For example, the R, G, B, and W data can be created by data conversion means (not illustrated). In this case, it is preferable that image data obtained by the image data obtainment section 6 are converted by the data conversion means, and the voltage application section 5 applies voltages in accordance with pixel data contained in the image data thus converted.

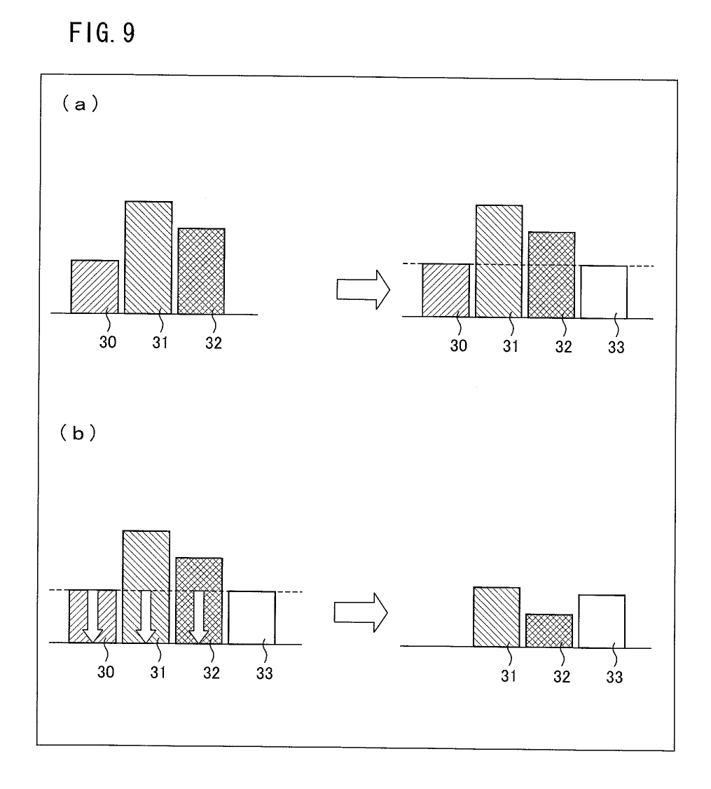

In the liquid crystal display device 1, after the R, G, and B data are inputted, W data is created based on the R, G, and B data. FIG. 9 is a view explaining a procedure to create the W data from input data in the liquid crystal display device 1.

In a case where the input data obtained by the image data obtainment section 6 are a red (R) 30, a green (G) 31, and a blue (B) 32, W data is created by determining a value of white 34, based on a value of the smallest one of R, G, and B (see (a) of FIG. 9) (in the case of (a) of FIG. 9, a value of the red 30 is the smallest). After this, a value of the W data is subtracted from each of the values of the respective R, G, and B in the input data (see (b) of FIG. 9). This creates R, G, and B display data to be supplied to the display 2.

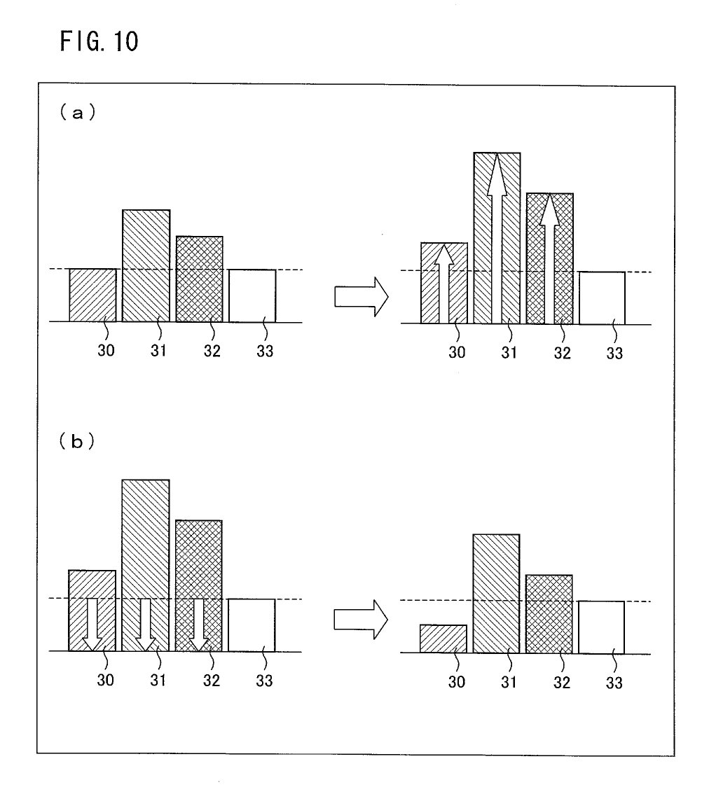

Then, pixel data of the first region are created by use of the W data thus created by the method. FIG. 10 is a view explaining a procedure to create the R, G, B, and W data from input data in the liquid crystal display device 1.

First, values of R, G, and B data in the input data are expanded (see (a) of FIG. 10). For example, the values of R, G, and B data in the input data can be expanded by a degree between one-fold and two-fold. However, a degree of expansion is not limited to this. In this case, the value of the W data is not changed from the value found by the method illustrated in FIG. 9.

Then, the value of W data is subtracted from each of values of the expanded R, G, and B data to create R, G, B, and W data (see (b) of FIG. 10). The voltage application section 5 applies voltages on the pixel displaying the first region, based on luminances of the respective R, G, B, and W data thus created.

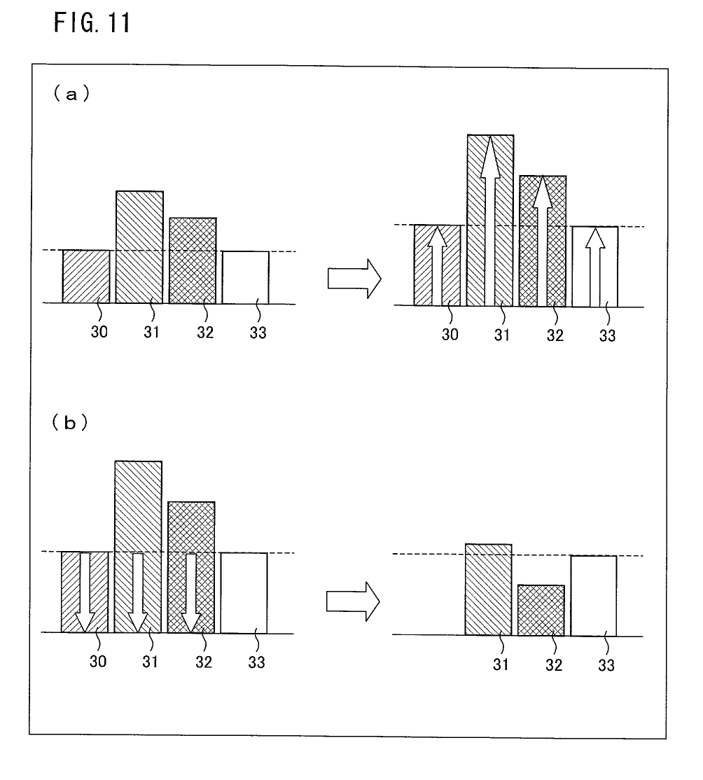

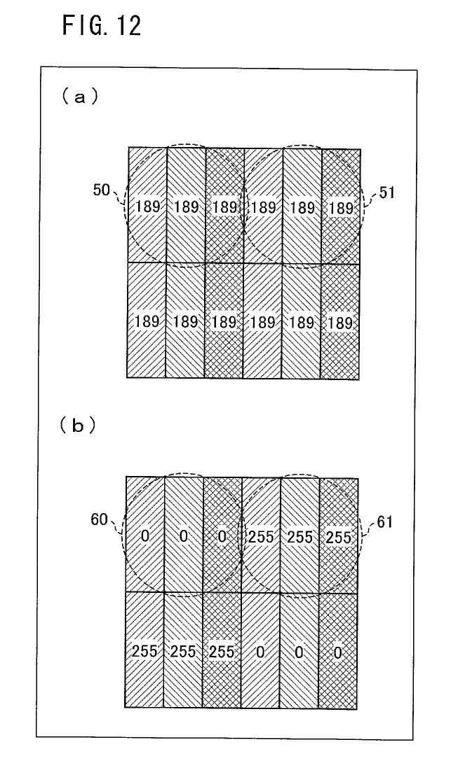

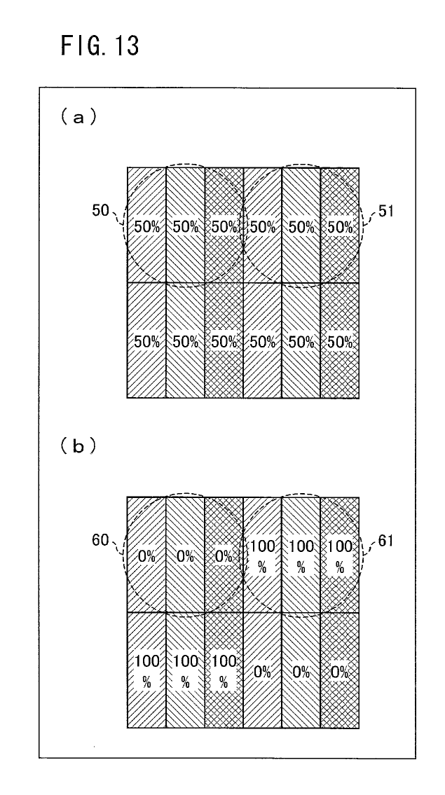

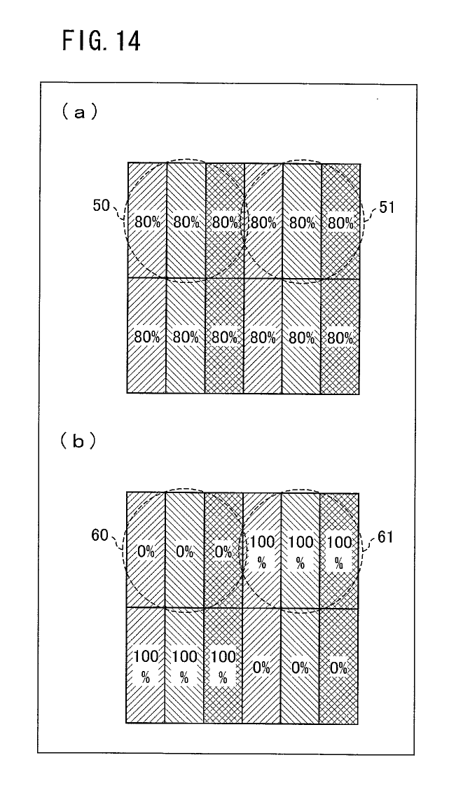

In contrast, image data indicative of the second region can be created by a method described as follows. FIG. 11 is a view explaining another procedure to create R, G, B, and W data from input data in the liquid crystal display device 1.

First, R, G, and B data in the input data and W data thus created by the method described in FIG. 9 are expanded in value (see (a) of FIG. 11). That is, in the present embodiment, in a case where the pixel data indicative of the second region is created, the R, G, B, and W data are expanded in value. The R, G, B, and W data are expanded ion value by a degree between one-fold and two-fold. However, a degree of expansion is not limited to this.

Then, a value of the expanded W data is subtracted from values of the respective expanded R, G, and B data (see (b) of FIG. 11) to create R, G, B, and W data. Then, the voltage application section 5 applies voltages on the pixel displaying the second region, based on luminances of the respective R, G, B, and W data.

Note that a method for creating R, G, B, and W data from input data (R, G, and B data) is not limited to the aforementioned example, and the R, G, B, and W data can be created from the input data (R, G, and B data) by a different method.

(Program and Recording Medium)

Finally, the blocks included in the liquid crystal display device 1 may be realized by way of hardware or software as executed by a CPU as follows:

The liquid crystal display device 1 includes a CPU and memory devices (storage media). The CPU executes instructions in control programs realizing the functions. The memory devices include an ROM (Read Only Memory) which contains programs, an RAM (Random Access Memory) to which the programs are loaded in an executable form, and a memory containing the programs and various data. With the configuration, the object of the present invention can also be achieved by given storage media.

The storage media need to store, in a computer-readable manner, program codes (executable program, intermediate code program, source program) for the programs in the liquid crystal display device 1 which are software realizing the aforementioned functions. The storage media are mounted to the liquid crystal display device 1. This needs to cause the liquid crystal display device 1 (or CPU, MPU) as the computer to retrieve and execute the program codes contained in the storage media thus mounted.

The storage medium from which the program code is delivered to the liquid crystal display device 1 is not limited to any particular arrangement or kind. That is, the storage medium may be, for example, a tape, such as a magnetic tape or a cassette tape; a magnetic disk, such as a floppy (Registered Trademark) disk or a hard disk, or an optical disk, such as CD-ROM/MO/MD/DVD/CD-R; a card, such as an IC card (memory card) or an optical card; or a semiconductor memory, such as a mask ROM/EPROM/EEPROM/flash ROM.

The object of the present invention can be realized even by an arrangement in which the liquid crystal display device 1 is connectable to a communications network. According to the arrangement, the program code is delivered to the liquid crystal display device 1 over the communications network. The communications network is not limited to any particular kind or arrangement, provided that the program code can be delivered to the liquid crystal display device 1 over the communications network. The communications network may be, for example, the Internet, an intranet, extranet, LAN, ISDN, VAN, CATV communications network, virtual dedicated network (virtual private network), telephone line network, mobile communications network, or satellite communications network.

A transfer medium which makes up the communications network is not limited to any particular arrangement or kind, provided that the transfer medium is a medium over which the program code can be delivered. The transfer medium can be, for example, wired line, such as IEEE 1394, USB (Universal Serial Bus), electric power line, cable TV line, telephone line, or ADSL (Asymmetric Digital Subscriber Line); or wireless, such as infrared radiation (IrDA, remote control), Bluetooth (Registered Trademark), 802.11 wireless, HDR, mobile telephone network, satellite line, or terrestrial digital network. The preset invention can be also realized in the form of a computer data signal which is embedded in a carrier wave and electronic transmission of which realizes the program code.

It is preferable that the liquid crystal display device of the present invention is configured so that said at least one of the sub-pixels in the pixel displaying the second region is a white sub-pixel, and said at least another one of the sub-pixels in the pixel displaying the second region includes a red sub-pixel, a green sub-pixel, and a blue sub-pixel.

Further, it is preferable that the liquid crystal display device of the present invention is configured so that said at least one of the sub-pixels in the pixel displaying the second region includes a red sub-pixel, a green sub-pixel, and a blue sub-pixel, and said at least another one of the sub-pixels in the pixel displaying the second region is a white sub-pixel. For example, in a case where a color is displayed with a certain gray scale, a displayed color would be different from the color if a luminance balance among red, green, and blue sub-pixels of a pixel is changed. In order to deal with this, the luminance balance among the red, green, and blue sub-pixels of the pixel is not changed, even in a case where there is a change in a pattern of applied voltages. This makes it possible that the color is displayed with the certain gray scale, by using any of a plurality of possible variations of voltage application patterns and without becoming different from an originally intended color.

The liquid crystal display device may be realized on a computer. In this case, the scope of the present invention encompasses a control program for realizing the liquid crystal display device on the computer by causing the computer to operate as each means. The scope of the present invention also encompasses a computer-readable storage medium in which the control program is stored.

### INDUSTRIAL APPLICABILITY

The liquid crystal display device of the present invention can be applied to any device in which privacy protection is required. More specifically, the liquid crystal display device of the present invention is suitably applicable in a mobile telephone, an electronic book reader, a portable game console, a personal digital assistant (PDA), a laptop computer, an automated teller machine (ATM), an electronic point of sale information management (EPOS) device, and the like.

### REFERENCE SIGNS LIST

1: liquid crystal display device
2: display
3: backlight
4: image output section
5: voltage application section (application means)
6: image data obtainment section (obtainment means)
7: viewing angle mode switch section
8: control section

1. A liquid crystal display device, comprising:
obtainment means for obtaining image data;
a display, which displays an image indicated by the image data obtained by the obtainment means and in which a plurality of pixels, each being made up of sub-pixels of at least four different elementary colors, are provided; and
application means for applying voltages on the plurality of pixels provided in the display,
a certain gray scale in a first region of the image being displayed in such a manner that the application means applies voltages corresponding to the certain gray scale respectively on sub-pixels of at least four different elementary colors in a pixel displaying the first region, and
the certain gray scale in a second region of the image which is different from the first region of the image being displayed in such a manner that the voltage application means applies, on at least one of sub-pixels in a pixel displaying the second region, a voltage larger than the voltage applied on one of the sub-pixels in the pixel displaying the first region which one corresponds in color to said at least one of the sub-pixels in the pixel displaying the second region, and the application means applies, on at least another one of the sub-pixels in the pixel displaying the second region, a voltage smaller than the voltage applied on another one of the sub-pixels in the pixel displaying the first region which another one corresponds in color to said at least another one of the sub-pixels in the pixel displaying the second region.

2. The liquid crystal display device as set forth in claim 1, wherein
said at least one of the sub-pixels in the pixel displaying the second region is a white sub-pixel, and said at least another one of the sub-pixels in the pixel displaying the second region includes a red sub-pixel, a green sub-pixel, and a blue sub-pixel.

3. The liquid crystal display device as set forth in claim 1, wherein
said at least one of the sub-pixels in the pixel displaying the second region includes a red sub-pixel, a green sub-pixel, and a blue sub-pixel, and said at least another one of the sub-pixels in the pixel displaying the second region is a white sub-pixel.

4. A display method, comprising the steps of:
(i) obtaining image data indicating an image to be displayed by a display in which a plurality of pixels, each being made up of sub-pixels of at least four different elementary colors, are provided; and
(ii) applying voltages on the plurality of pixels provided in the display,
a certain gray scale in a first region of the image being displayed in such a manner that in the step (ii), voltages corresponding to the certain gray scale are applied respectively on sub-pixels of at least four different elementary colors in a pixel displaying the first region, and
the certain gray scale in a second region of the image which is different from the first region of the image being displayed in such a manner that in the step (ii), on at least one of sub-pixels in a pixel displaying the second region, there is applied a voltage larger than the voltage applied on one of the sub-pixels in the pixel displaying the first region which one corresponds in color to said at least one of the sub-pixels in the pixel displaying the second region, and on at least another one of the sub-pixels in the pixel displaying the second region, there is applied a voltage smaller than the voltage applied on another one of the sub-pixels in the pixel displaying the first region which another one corresponds in color to said at least another one of the sub-pixels in the pixel displaying the second region.

5. A program causing a computer included in a liquid crystal display device as set forth in of claim 1 to operate, said program causing the computer to function as each means of the liquid crystal display device.

6. A computer-readable storage medium, in which the program as set forth in claim 5 is stored.
